(19) United States
(12) Patent Application Publication
(10) Pub. No.: US 2003/0098310 A1
(43) Pub. Date: May 29, 2003

(54) Tip resistant bowl

(76) Inventor: Dorothea McGee, Paterson, NJ (US)

Correspondence Address: Mr. Walter J. Tencza Jr., Suite 3, 10 Station Place, Metuchen, NJ, 08840, US

(21) Appl. No.: 10/001,313

(22) Filed: Nov. 28, 2001

(51) Int. Cl. A47G 19/00; A47G 21/00; A47G 23/00

(52) U.S. Cl. 220/574.3

(57) ABSTRACT

A tip resistant, stackable, disposable, lightweight bowl is provided. The tip resistant bowl is particularly useful for feeding or supplying drinks to pets or young children. The tip resistant bowl prevents or limits the amount of spillage of liquid or solid food. In one embodiment of the present invention a bowl is provided comprising an inner wall, an outer wall connected to the inner wall, an inner base connected to the inner wall, and an outer base connected to the outer wall. The inner wall and the inner base form a receptacle which can receive and hold liquid or food. The inner wall and the outer wall may define a cavity. The inner wall may be at about a one hundred degree angle with respect to the base.

### FIELD OF THE INVENTION

This invention relates to improved methods and apparatus concerning preventing pets or small children from spilling liquid or food provided to them.

### BACKGROUND OF THE INVENTION

Typically in the prior art, bowls can be easily tipped over by a pet or a small child. This may undesirably cause liquid, such as milk, or food stored in the bowls to spill or drop onto a floor or other indoor surface. This problem is exacerbated when lightweight disposable bowls are used. These lightweight disposable bowls are particularly susceptible to being tipped over.

U.S. Design Pat. No. 423,732 to McGee, discloses a bowl which has a base portion in the shape of an outer ring which is connected or integrated with a receptacle portion. U.S. Design Pat. No. 423,732 to McGee discloses a single wall for the receptacle portion and for the bowl generally.

### SUMMARY OF THE INVENTION

The present invention provides a tip resistant and stackable bowl which can be used for serving food, drink, or any other type of nourishment, and for any other use for which bowls generally are provided. The tip resistant bowl is particularly useful for feeding or supplying drinks to pets or small children. The tip resistant bowl prevents or limits the amount of spillage of liquid or solid food.

In one embodiment of the present invention a bowl is provided comprising an inner wall, a rim connected to the inner wall, an outer wall connected to the rim, an inner base connected to the inner wall, and an outer base connected to the outer wall. The inner wall and the inner base form a receptacle which can receive and hold liquid or food. The inner wall and the outer wall may define a cavity. The inner wall may be at about a one hundred degree or more angle with respect to the inner base. The inner wall, the outer wall, and the outer base may be ring shaped and the inner base may be circular shaped. The inner wall and the outer wall may be connected together to define a rim. The bowl may be disposable and comprised of a lightweight material. The inner wall, the outer wall, the inner base and the outer base may be integrated together.

The present invention also includes a method comprising the steps of forming a bowl comprised of an inner wall, an outer wall connected to the inner wall, an inner base connected to the inner wall, an outer base connected to the outer wall, wherein the inner wall and the inner base form a receptacle which can receive and hold liquid or food. The method may also include pouring a liquid into the receptacle; and providing the liquid in the receptacle to a small child or to a pet.

### BRIEF DESCRIPTION OF THE DRAWINGS

FIG. 1 shows a perspective view of a bowl in accordance with an embodiment of the present invention;

FIG. 2 shows a front view of the bowl of FIG. 1;

FIG. 3 shows a bottom view of the bowl of FIG. 1;

FIG. 4 shows a top view of the bowl of FIG. 1; and

FIG. 5 shows a cross sectional view of the bowl of FIG. 1 along line AB shown in FIG. 4.

### DETAILED DESCRIPTION OF THE DRAWINGS

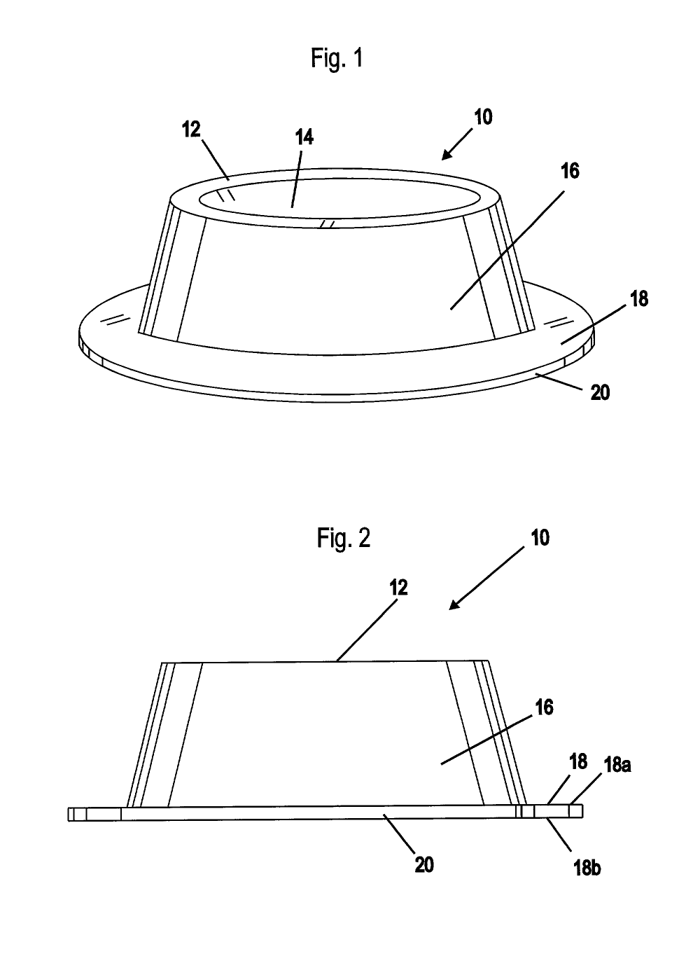

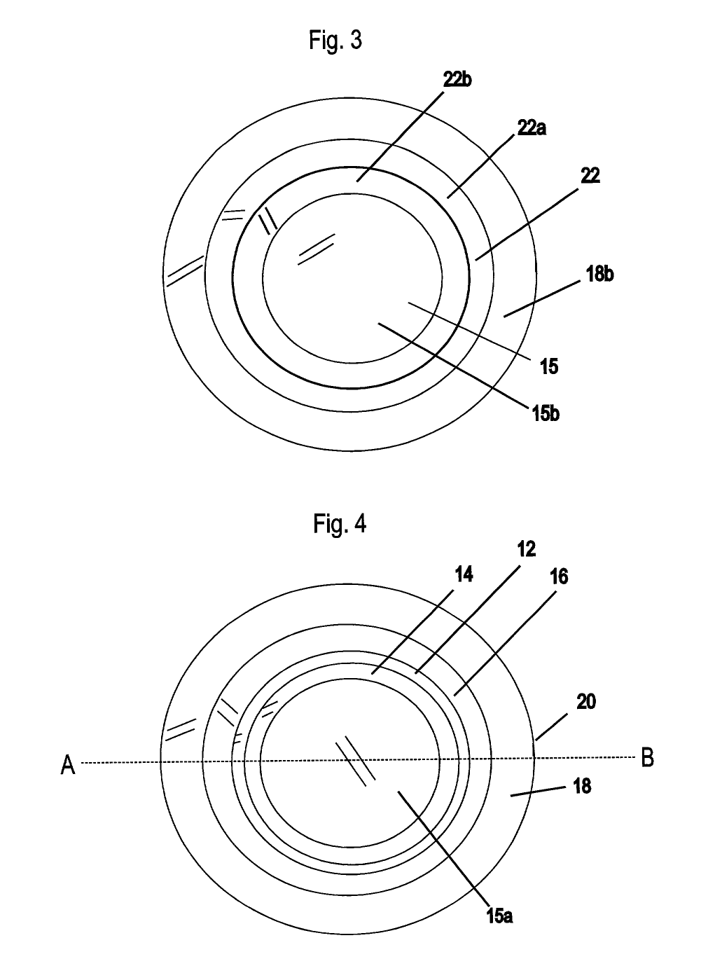

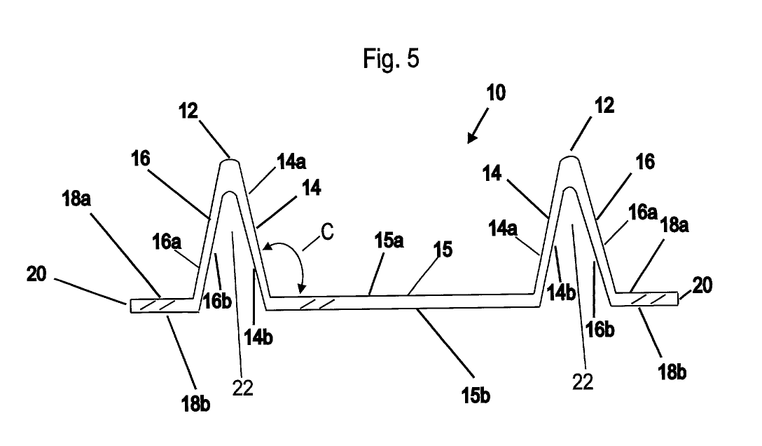

FIG. 1 shows a perspective view of a bowl 10 in accordance with an embodiment of the present invention. FIG. 2 shows a front view of the bowl 10. FIG. 3 shows a bottom view of the bowl 10. FIG. 4 shows a top view of the bowl 10. FIG. 5 shows a cross sectional view of the bowl 10 of FIG. 1 along line AB shown in FIG. 4.

The bowl 10 includes a rim 12, an inner wall 14, an inner base 15 (shown in FIG. 3), an outer wall 16, an outer base 18, and an edge 20. The inner wall 14 is connected to the inner base 15 as shown in FIG. 5. The inner wall is connected at one end to one end of the outer wall 16 resulting in rim 12. The outer wall 16 is connected at its other end to one end of the outer base 18. The inner base 15 includes a top surface 15a show in FIG. 4 and a bottom surface 15b shown in FIG. 3. The outer base 18 includes a top surface 18a and a bottom surface 18b as shown by FIGS. 3, 4, and 5. The inner wall 14 has a surface 14a and a surface 14b. The outer wall 16 has a surface 16a and a surface 16b. The inner wall 14 by its surface 14b and the outer wall 16 by its surface 16b define a cavity 22 as shown by FIG. 5. The inner wall 14 be at an angle C, which may be about one hundred degrees or more, with respect to the inner base 15. The rim 12, inner wall 14, outer wall 16, and outer base 18 may be integrated together and each may have a ring shape.

The inner wall 14 and the inner base 15 define a chamber, receptacle, or chamber or receptacle region in which a liquid such as milk, can be placed for a pet, such as a cat. Food can also be placed in the receptacle. The food or liquid can be provided to a child. The bowl 10 is structured so that it is difficult for a pet or a child to spill the liquid or food by tipping the bowl 10 over. The bowl 10 can be said to be tip resistant. The outer wall 16 and the outer base 18 provide support for the bowl 10 to prevent it from being tipped from its upright position shown in FIG. 1 or FIG. 5. The bowl 10 can be made of a lightweight material such as plastic, foam, paper, or foil and can be disposable. The bowl 10 can be made of the same kind of material that prior art disposable bowls are made of. However prior art bowls typically can be easily tipped over by a pet or a child, for example.

As shown in FIG. 5, the rim 12 has a curved edge. The curved edge aids in stacking and dissipates stress, as opposed to a sharp edge or angle which creates stress on certain plastic materials, especially if handled roughly during shipping.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. A bowl comprising:
an inner wall;
a rim connected to the inner wall;
an outer wall connected to the rim;
an inner base connected to the inner wall;
an outer base connected to the outer wall; and
wherein the inner wall and the inner base form a receptacle which can receive and hold nourishment.

2. The bowl of claim 1 wherein
the nourishment is liquid.

3. The bowl of claim 1 wherein
the nourishment is solid food.

4. The bowl of claim 1 wherein
the inner wall and the outer wall define a cavity.

5. The bowl of claim 1 wherein
the inner wall is at about a one hundred degree angle with respect to the inner base.

6. The bowl of claim 1 wherein
the inner wall, the outer wall, and the outer base are ring shaped; and
the inner base is circular shaped.

7. The bowl of claim 1 wherein
the bowl is disposable.

8. The bowl of claim 1 wherein
the bowl is comprised of a lightweight material.

9. The bowl of claim 1 wherein
the inner wall, the outer wall, the inner base and the outer base are integrated together.

10. A method comprising the steps of
forming a bowl comprised of
an inner wall;
a rim connected to the inner wall;
an outer wall connected to the rim;
an inner base connected to the inner wall;
an outer base connected to the outer wall; and
wherein the inner wall and the inner base form a receptacle which can receive and hold nourishment.

11. The method of claim 10 wherein
the nourishment is food.

12. The method of claim 10 wherein
the nourishment is liquid.

13. The method of claim 12 further comprising
pouring a liquid into the receptacle; and
and providing the liquid in the receptacle to a pet.

14. The method of claim 12 further comprising
pouring a liquid into the receptacle; and
and providing the liquid in the receptacle to a child.

15. The method of claim 10 wherein
the inner wall and the outer wall define a cavity.

16. The method of claim 10 wherein
the inner wall is at about a one hundred degree angle with respect to the inner base.

17. The method of claim 10 wherein
the inner wall, the outer wall, and the outer base are ring shaped; and
the inner base is circular shaped.

18. The method of claim 10 wherein
the bowl is disposable.

19. The method of claim 10 wherein
the bowl is comprised of a lightweight material.
